(19) United States
(12) Patent Application Publication
(10) Pub. No.: US 2025/0226009 A1
(43) Pub. Date: Jul. 10, 2025

(54) DATA STORAGE DEVICE THAT INCLUDES AT LEAST ONE LUBRICATED FASTENER, AND RELATED FASTENERS AND METHODS

(71) Applicant: Seagate Technology LLC, Fremont, CA (US)

(72) Inventors: Michael Yi Zhao Yao, Singapore (SG); Bo Shi, Wuxi (CN); Alice Kim Tai Chin, Singapore (SG); Daniel R. Stevens, Longmont, CO (US); George Humberto Faraco, Westminster, CO (US); Siong Choon Teo, Johor Bahru (MY); Tsuny Ming Boh, Singapore (SG); Teck Wei Tan, Singapore (SG); Jackson W. Nichols, Belle Plaine, MN (US); Nathan Thamilmani Senthil, Singapore (SG)

(21) Appl. No.: 18/974,242

(22) Filed: Dec. 9, 2024

Related U.S. Application Data
(60) Provisional application No. 63/618,101, filed on Jan. 5, 2024.

(51) Int. Cl. G11B 33/12; F16B 33/06

(52) U.S. Cl. CPC G11B 33/124; F16B 33/06; G11B 2220/2516

(57) ABSTRACT

Fasteners such as stainless-steel screws used to physically couple at least one component within a housing of a data storage device such as a hard disk drive to secure the at least one component within the housing. The fasteners are made by first pre-treating the fasteners to form sufficient metal oxide prior to coating the fasteners in one or more lubricants.

### CROSS-REFERENCE TO RELATED APPLICATION

This nonprovisional patent application claims the benefit of U.S. Provisional Patent Application Ser. No. 63/618,101, filed on Jan. 5, 2024, wherein said provisional patent application is incorporated herein by reference in its entirety.

### SUMMARY

The present disclosure includes embodiments of a fastener including:
an elongated metal fastener body including:
   a first end;
   an opposed second end; and
   a length extending between the first end and the second end;
a metal head at the first end of the elongated body, wherein the elongated metal fastener body and the metal head have an exterior surface including metal oxide; and
a lubricant coating over the entire exterior surface of the elongated metal fastener body and the metal head, wherein the lubricant coating includes one or more liquid lubricants, and wherein the fastener has a reject rate of 1% or less according to the Brush Test.

The present disclosure also includes embodiments of a fastener including:
an elongated metal fastener body including:
   a first end;
   an opposed second end; and
   a length extending between the first end and the second end;
a metal head at the first end of the elongated body, wherein the elongated metal fastener body and the metal head have an exterior surface including metal oxide; and
a lubricant coating over the entire exterior surface of the elongated metal fastener body and the metal head, wherein the metal oxide is present over all of the exterior surface of the elongated metal fastener body and the metal head, and wherein all of the exterior surface of the elongated metal fastener body and the metal head has a surface-oxygen content of at least 8 percent by weight as measured by 2 kilovolts (kV) scanning electron microscopy (SEM) with 2 kilovolts (kV) energy-dispersive X-ray (EDX) spectroscopy.

The present disclosure also includes embodiments of a method of forming a plurality of fasteners, wherein the method includes:
providing a plurality of metal fasteners exposed to ambient air, wherein each metal fastener has an exterior surface;
exposing the plurality of metal fasteners to non-ambient air conditions to form metal oxide on the exterior surface; and
coating a lubricant over the entire exterior surface, wherein the lubricant includes a liquid lubricant, and wherein the fastener has a reject rate of 0% according to the Brush Test.

### BRIEF DESCRIPTION OF THE DRAWINGS

The discussion below makes reference to the following figures, wherein the same reference number may be used to identify the similar/same component in multiple figures. The schematic figures are for illustration purposes and are not necessarily drawn to scale.

FIG. 1A is an exploded perspective view illustrating a non-limiting example of a data storage device having a component secured within the device using a plurality of fasteners;

FIG. 1B is a partial view of FIG. 1A showing a close-up view of a fastener 70 in FIG. 1A;

FIG. 2 is a partial cross-sectional, schematic view illustrating an example of a fastener that has not been exposed to non-ambient air conditions (e.g., no pre-baking) to form metal oxide on the exterior surface such that after coating a lubricant over the entire exterior surface, the fastener has a reject rate of approximately 5% according to the Brush Test like in Groups 1 and 5 of Table 2;

FIG. 3 is a partial cross-sectional, schematic view of a fastener according to the present disclosure that has been exposed to non-ambient air conditions to form metal oxide on the exterior surface such that after coating a lubricant over the entire exterior surface, the fastener has a reject rate of 0% according to the Brush Test;

FIG. 4 is a partial, exploded view of several components within a hard disk drive housing.

FIG. 5 is a photograph showing an example of a fastener that includes black stains due to particles according to the Brush Test;

FIG. 6 is a photograph showing an example of a fastener that includes black stains due to particles according to the Brush Test; and

FIG. 7 is a photograph showing an example of a fastener that does not include any black stains according to the Brush Test.

### DETAILED DESCRIPTION

The present disclosure involves electronic devices that include a sealed enclosure having an interior gas space, and one or more electrical components disposed in the sealed enclosure. In some embodiments, an electronic device is a data storage device. Non-limiting examples of data storage devices include hard disk drives (HDDs) (internal and/or external), network attached storage (NAS), and the like. Examples of hard disc drives are reported in U.S. Pat. No. 7,478,760 (Beatty et al.) and U.S. Pat. No. 7,695,547 (Smith), wherein the entireties of said patents are incorporated herein by reference.

Various types of magnetic recording mechanisms are used in hard disk drive products. Example types include longitudinal magnetic recording (LMR), perpendicular magnetic recording (PMR), shingled magnetic recording (SMR), and heat assisted magnetic recording (HAMR). A heat-assisted magnetic recording mechanism may be used in conjunction with an LMR, PMR, or SMR technique, to achieve higher areal storage density. A hard disk drive as described may include any of these types of recording mechanisms.

A hard disk drive includes electronic and mechanical components contained in a controlled environment of a sealed enclosure. Basic structures of a disk drive include a magnetic recording medium such as one or more magnetic hard disks disposed within the enclosure; one or more heads that include one or more transducers for writing or reading magnetically-recorded data relative to the magnetic hard disk; and electrical and mechanical components that manage the operation of magnetic disks and heads to allow the drive to function to store and retrieve magnetically-recorded digital information.

A variety of components within a data storage device such as a hard disk drive are secured within the housing using one or more fasteners. A fastener physically engages a component and another substrate to secure the component within the housing.

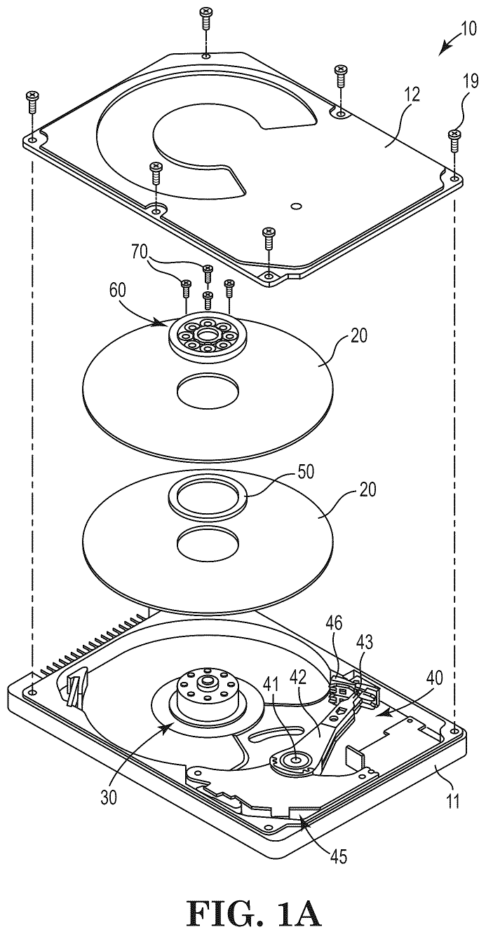

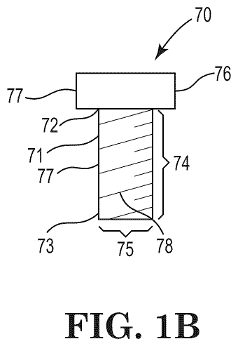

A variety of types of fasteners can be made according to the present disclosure. As used herein, a “fastener” is used to secure a component within a housing a data storage device. In general, a fastener has an elongated metal fastener body and a metal head located at one end of the elongated metal fastener body (see FIGS. 1A and 1B, described below). Non-limiting examples of fasteners include screws, nails rivets, bolts, and the like.

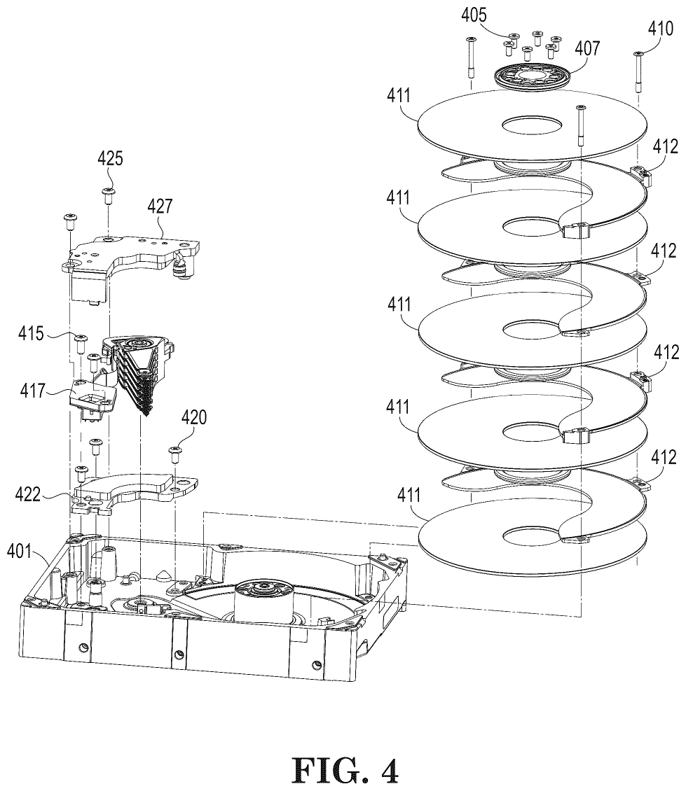

A wide variety of components in a data storage device such as a hard disk drive can be mounted or secured with the hard disk drive using fasteners such as stainless-steel screws. Non-limiting examples of such components include a disk clamp, disk separator plates, head stack bracket, bottom voice coil magnetic assembly (VCMA), top VCMA, ramp structure (for recording heads), combinations thereof, and the like. FIG. 4 illustrates non-limiting examples of components that can be mounted within a hard disk drive housing using fasteners made according to the present disclosure. The housing base 401 is shown, but the housing cover is not shown. As shown in FIG. 4, six fasteners 405 physically engage with disk clamp 407 to secure the disk clamp 407. Three fasteners 410 physically engage with each of four disk separator plates 412 positioned between five disks 411 to secure each of disk separator plates 412. Two fasteners 415 physically engage with the head stack bracket 417 to secure the head stack bracket 417. Three fasteners 420 physically engage with bottom voice coil magnetic assembly (VCMA) 422 to secure bottom VCMA 422. Two fasteners 425 physically engage with top VCMA 427 to secure top VCMA 427. An example of a ramp structure is illustrated in U.S. Pat. No. 11,830,530 (Zhang et al.), wherein the entirety of said patent is incorporated herein by reference.

A non-limiting example of a component fastened within the housing of a data storage device using a plurality of fasteners is illustrated in FIG. 1A. Referring to FIG. 1A, data storage device 10 is shown as a hard disk drive that includes a base member 11, a spindle motor 30 mounted to the base member 11 for rotating a disk 20, which is a storage medium for storing data, and an actuator 40 for moving a read/write head to a desired position on the disk 20.

The spindle motor 30 is installed to the base 11. The spindle motor 30 may be provided with two disks, as illustrated in FIG. 1A, or may be provided with one or more than two disks. In the case where a plurality of disks are mounted to the spindle motor 30, a ring-shaped spacer 50 may be positioned between each disk 20 to maintain a distance between the disks 20. A component 60 shown as a disk clamp 60 is engaged to an upper end of the spindle motor 30 by use of four fasteners 70 shown as threaded, stainless steel screws to physically couple and rigidly secure the disks 20 to the spindle motor 30 within an interior gas space of housing formed by cover and base 11.

As shown in FIG. 1B, each of the four fasteners 70 has an elongated metal fastener body 71 having a first end 72 and an opposed second end 73. The elongated metal fastener body 71 also has a length 74 extending between the first end 72 and the second end 73, and width 75. The cross-section along the length 75 can be any desirable shape such as circular, square, and the like. In some embodiments, the cross-section is circular so width 75 corresponds to a diameter. Each fastener 70 has a metal head 76 located at the first end 72 of the elongated metal fastener body 71. The elongated metal fastener body 71 and the metal head 76 have an exterior surface 77 that includes metal oxide. As can be seen in FIG. 1B, each fastener 70 has threads 78 on the exterior surface 77 for physically engaging one or more substrates to physically couple component 60 within the housing of data storage device 10.

Referring back to FIG. 1A, the actuator 40 includes a swing arm 42, rotatably coupled to a pivot bearing 41 installed on the base member 11, a suspension 43 installed on one end portion of the swing arm 42 for supporting and elastically biasing a slider (not shown), on which the head is mounted, toward the surface of the disk 20, and a voice coil motor (VCM) 45 for rotating the swing arm 42. The voice coil motor 45 is controlled by a servo control system. The swing arm 42 is rotated in a direction according to the Fleming's left-hand rule by the interaction between an electric current input to a VCM coil and a magnetic field generated by magnets. Specifically, when the disk 20 starts spinning, upon the hard disk drive being turned on, the voice coil motor 45 rotates the swing arm 42 in a counterclockwise direction to move the head to a desired position on a recording surface of the disk 20. When the disk 20 stops spinning when the hard disk drive is turned off, the voice coil motor 45 rotates the swing arm 42 in a clockwise direction to move the head away from the disk 20. At this time, the head deviating from the recording surface of the disk 20 is parked on a ramp 46 provided outside of the disk 20.

A cover member 12 is assembled to the upper portion of the base member 11, using a plurality of fasteners 19 shown as threaded screws. The disk 20, the spindle motor 30 and the actuator 40 are enclosed in and protected by the base member 11 and the cover member 12 coupled to each other to form the housing.

The interior space of many data storage devices such as hard disk drives are sensitive to particle debris. Fasteners can generate particle debris during the fastening process due to friction between the fastener, component to be fastened, and/or any other substrate that the fastener physically engages with. Some lubricated fasteners can also contribute to lubricant migration from the lubricated fastener to elsewhere within the data storage device. One or more components within a data storage device can be sensitive to lubricant migration (e.g., organic contamination). Also, some sealed, hard disk drives include a gas mixture of at least helium and oxygen, where the oxygen is included in relatively minor amounts. The oxygen can serve one or more beneficial purposes during the life of the sealed, hard disk drive. Exposed metal surfaces of a fastener can react with oxide to form metal oxide and reduce the oxygen content in a sealed, hard disk drive to an undue degree.

According to the present disclosure, methods of making fasteners involves growing metal oxide on the exterior of metal fasteners followed by coating one or more lubricants over the entire exterior surface. The previously grown metal oxide can improve lubricant bonding strength to the metal fasteners and/or distribution (uniformity) of the lubricant over the exterior surface of the fasteners. By enhancing the coverage and bond strength of the lubricant due to the pre-oxidation treatment according the present disclosure, migration of lubricant (organic material) can advantageously be reduced and/or the consumption of oxygen with the hard disk drive interior by the stainless steel in the fastener can advantageously be reduced. Also, by enhancing the coverage and bond strength of the lubricant due to the pre-oxidation treatment according the present disclosure particle contamination can be reduced. Further, the presence of previously grown metal oxide over substantially all of the metal fastener can help avoid exposing underlying bare metal fastener surfaces to oxygen within a sealed, hard disk drive, which can undesirably consume oxygen by forming metal oxide. In some embodiments, fasteners made according to the present disclosure have a reject rate of 1% or less, 0.5% or less, or even 0% according to the Brush Test (discussed below).

A method according to the present disclosure involves obtaining a plurality of metal fasteners that have already been formed into the shape of a fastener. Such fasteners typically include some native surface oxide. For example, because metal fasteners can be exposed to ambient air, which includes about 21% oxygen, the exterior surfaces of metal fasteners can have an amount of one or more native metal oxides that is already present prior to a process according to the present disclosure. According to the present disclosure and as further discussed below, fasteners are pre-treated to grow additional metal oxide on the exterior surface of the fasteners beyond any native oxide that may be present to enhance the bonding of the subsequently applied lubricant so that there is no undue exposure of underlying stainless steel that has not formed sufficient metal oxide at the exterior surface of the metal fastener.

As mentioned, fasteners according to the present disclosure are made of one or more metals. In some embodiments, the one or more metals include one or more stainless steel compositions (“stainless steel”). Stainless steel is an alloy of iron that includes at least chromium. Stainless steel is resistant to corrosion because chromium can form a passive film that can protect the underlying material and self-heal in the presence of oxygen. Stainless steel can include one or more additional elements such as carbon, nickel, manganese, silicon, phosphorus, sulfur, copper, nitrogen, combinations thereof, and the like. In some embodiments, a fastener can include austenitic stainless steel, martensitic stainless steel, and combinations thereof. Austenitic stainless steel has a microstructure achieved by alloying steel with sufficient nickel and/or manganese, and nitrogen. Martensitic stainless steel has a relatively lower chromium content as compared to austenitic stainless steel.

Different types of stainless steel are labeled with an American Iron and Steel Institute (AISI) three-digit number. ISO 15510 standard identifies the chemical compositions of stainless steels of the specifications in standards such as ASTM, etc.

Non-limiting examples of stainless steel include AISI type 410SS (e.g., SUS410 or ANSI SS410); AISI type 302 or SS302HQ; UNS 24100 modified (anti-galling). AISI type 410SS is a martensitic stainless steel that has the following composition: up to 0.15% wt. carbon; up to 1% wt. manganese; up to 1% wt. silicon; up to 0.04% wt. phosphorus; up to 0.03% wt. sulfur; from 11.5 to 13.5% wt. chromium; greater than 0.75% wt. nickel; and balance iron. UNS 24100 is an austenitic stainless steel that has the following composition: up to 0.15% wt. carbon; from 11.0 to 14.0% wt. manganese; up to 1% wt. silicon; up to 0.045% wt. phosphorus; up to 0.030% wt. sulfur; from 16.5 to 19.0% wt. chromium; from 0.2 to 0.45% wt. nitrogen; from 0.5 to 2.5% wt. nickel; and balance iron. SS302HQ is an austenitic stainless steel that has the following composition: up to 0.03% wt. carbon; up to 2.00% wt. manganese; up to 1% wt. silicon; up to 0.045% wt. phosphorus; up to 0.03% wt. sulfur; from 17.0 to 19.0% wt. chromium; from 8.0 to 10.0% wt. nickel; from 3.0 to 4.0% wt. copper; and balance iron.

As mentioned, according to the present disclosure, fasteners are pre-treated to grow metal oxide on the exterior surface of the fasteners beyond any native oxide that may be present so that there is no undue exposure of underlying stainless steel that has not formed sufficient metal oxide at the exterior surface of the metal fastener. Growing sufficient metal oxide on metal fasteners according to the present disclosure enhances the bonding of subsequently applied lubricant. While not being bound by theory, it is believed that growing sufficient metal oxide serves as bonding or anchoring sites to lubricant molecules to make the lubricant bond to metal oxide relatively stronger and relatively more uniform. Also, while not being bound by theory, it is believed that the enhanced bonding of the lubricant to the fastener is due to hydrogen bonding between the lubricant and surface oxygen and/or surface hydroxy groups in the metal oxide that is grown.

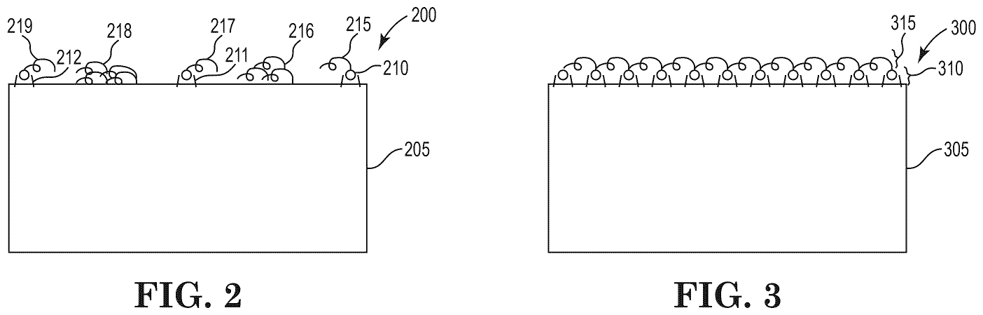

Growing metal oxide on the surface of a fastener is further illustrated with respect to FIGS. 2 and 3. As shown in FIG. 2, a fastener 200 having a stainless-steel base 205 with limited sites 210, 211, and 212, of metal oxide at the exterior surface, thereby leaving substantial area of exposed stainless steel at the exterior surface. While there is some partially bonded lubricant 215 to site 210, partially bonded lubricant 217 to site 211, and partially bonded lubricant 219 to site 212, there is substantially exterior surface of fastener 200 that has no lubricant. Also, there are some agglomerated islands of lubricant on the exterior surface of fastener 200 where there are no sites of metal oxide.

In contrast, FIG. 3 illustrates a fastener 300 having essentially a layer 310 of metal oxide at the exterior surface of stainless-steel base 305, instead of relatively far apart sites, because fastener 300 was pre-treated to grow metal oxide on the exterior surface of the fastener 300 beyond any native oxide that may be present.

The metal oxide can be formed by a variety of techniques. In general, growing metal oxide according to the present disclosure involves exposing a plurality of metal fasteners to non-ambient air conditions to form metal oxide on the exterior surface. One non-limiting example of forming a metal oxide includes baking the metal fasteners in the presence of a gas including oxygen (e.g., air) at an elevated temperature for a time period to form sufficient metal oxide over the entire surface of the fasteners. In some embodiments, the fasteners are exposed to a gas including oxygen a temperature of 200° C. or greater for 30 minutes or more. In some embodiments, the temperature of the gas is at a temperature of at least 250° C. In some embodiments, the temperature of the gas is at a temperature from 200° C. to 800° C., from 200° C. to 700° C., or even from 250° C. to 700° C. The fasteners can be exposed to an elevated temperature by, e.g., positioning them in an oven such as convection oven, and heating the fasteners at a temperature for a time period as described herein. For example, a plurality of fasteners can be positioned within an oven to facilitate good contact between the hot gas and the entire surface of each fastener. In some embodiments, the fasteners can be positioned on a tray or bin at a relatively shallow depth (e.g., 0.5 to 1 cm) to facilitate good contact between the hot gas and the entire surface of each fastener. In some embodiments, the time period of exposure to an elevated temperature is from 30 minutes to 50 hours, from 1 hour to 20 hours, from 3 hours to 20 hours, or even from 3.5 hours to 20 hours.

Another non-limiting example of exposing the plurality of metal fasteners to non-ambient air conditions to form metal oxide on the exterior surface includes contacting the plurality of metal fasteners with aqueous composition including one or more oxidizing agents at a temperature for a time period to form sufficient metal oxide over the entire surface of the fasteners. For example, the plurality of fasteners can be soaked (e.g., submerged in a bath) in an aqueous solution of one or more oxidizing agents. In some embodiments, the temperature of the aqueous solution can be from 20° C. to 90° C., or even from 25° C. to 80° C. In some embodiments, the time period of contact with the aqueous solution is at least one hour. In some embodiments, the time period of contact with the aqueous solution is from one hour to 50 hours, from 3 hours to 20 hours, or even from 5 hours to 20 hours.

A wide variety of oxidizing agents, and concentrations thereof, can be selected for an aqueous solution to form sufficient metal oxide over the entire surface of the fasteners. Non-limiting examples of suitable oxidizing agents include ozone, oxygen, one or more peroxides (e.g., hydrogen peroxide), potassium nitrate, nitric acid, perchloric acid, sulfuric acid, one or more hexavalent chromium compounds (e.g., chromic acid, dichromic acid, and chromium trioxide), one or more chromate compounds, one or more dichromate compounds (e.g., sodium dichromate and potassium dichromate), one or more permanganate compounds (e.g., potassium permanganate), and mixtures thereof.

The composition of the metal oxide can depend on factors such as the composition of the stainless-steel fasteners and the oxidizing conditions (e.g., the oxidizing agent(s)). Non-limiting examples of the metal oxide include one or more of iron oxide, chromium oxide, nickel oxide, etc.

The metal oxide that is grown according to the present disclosure can be quantified and reported as percent by weight of surface-oxygen content using scanning electron microscopy (SEM) and energy-dispersive X-ray (EDX) spectroscopy (sometimes referred to as SEM/EDX). SEM is used for inspection and images, while EDX is used for analysis of chemical elements. In general, the lower the accelerating voltage for SEM, the clearer the surface structure. Also, the lower the accelerating voltage for EDX, the shallower the elemental analysis. 2 kilovolts (kV) for SEM and EDX is excellent for surface structure inspection and elemental analysis, respectively. For EDX, surface-oxygen content in terms of percent by weight can be determined by using the following parameters: 2 kilovolts (kV) accelerating voltage; magnification fixed at either 100× or 200×; and a fixed working distance in the range from 10 to 12 mm. A wide variety of SEM and EDX instruments are commercially available such as SEM instruments from ZEISS and EDX instruments from Oxford Instruments. In some embodiments, all of the exterior surface of the fasteners has a surface-oxygen content, prior to lubricant coating, of at least 8 percent by weight, at least 9 percent by weight, at least 10 percent by weight, at least 11 percent by weight, at least 12 percent by weight, at least 13 percent by weight, at least 14 percent by weight, or even at least 15 percent by weight as measured by 2 kilovolts (kV) scanning electron microscopy (SEM) with 2 kilovolts (kV) energy-dispersive X-ray (EDX) spectroscopy. In some embodiments, all of the exterior surface of the fasteners has a surface-oxygen content, prior to lubricant coating, of 50 percent by weight or less, or even 25 percent by weight or less as measured by 2 kilovolts (kV) scanning electron microscopy (SEM) with 2 kilovolts (kV) energy-dispersive X-ray (EDX) spectroscopy. In some embodiments, all of the exterior surface of the fasteners has a surface-oxygen content, prior to lubricant coating, from 13 percent to 30 percent by weight as measured by 2 kilovolts (kV) scanning electron microscopy (SEM) with 2 kilovolts (kV) energy-dispersive X-ray (EDX) spectroscopy.

In some embodiments, prior to growing an oxide layer, the plurality of fasteners can be cleaned (e.g., degreasing and aqueous washing).

After growing an oxide layer on a plurality of fasteners according to the present disclosure, one or more lubricants can be coated onto the fasteners. A wide variety of lubricants and lubricant mixtures can be used to coat fasteners for use in a hard disk drive. Non-limiting examples of lubricants include one or more semi-solid lubricants, one or more solid lubricants, and combinations thereof. One or more lubricants can be selected for coating fasteners based on one of factors such as processability (ability to coat), handling, and the environment within a hard disk drive where they will be used to secure components.

Liquid lubricants include one or more mineral oils, one or more synthetic oils, and combinations thereof. Liquid lubricants are mainly linear hydrocarbons, branched hydrocarbons, polyalkylene glycols (PAG), polyesters, fluorocarbons, etc. Mineral oils are derived from crude oil. The American Petroleum Institute (API) refers designates several types. Group I include less than 90% saturates, greater than 0.03% sulfur, and have a Society of Automotive Engineers (SAE) viscosity index (VI) of 80 to 120. Group II include greater than 90% saturates, less than 0.03% sulfur, and have a Society of Automotive Engineers (SAE) viscosity index (VI) of 80 to 120. Group III include greater than 90% saturates, less than 0.03% sulfur, and have a Society of Automotive Engineers (SAE) viscosity index (VI) of over 120. Group IV includes polyalphaolefins (PAO). Group V includes all others not included in Groups I-IV, such as naphthenics, polyalkylene glycols, and polyesters. Synthetic oils are produced using synthetic hydrocarbons, which are ultimately derived from petroleum. Non-limiting examples of synthetic oils include polyalpha-olefin (PAO), synthetic esters, polyalkylene glycols (PAG), phosphate esters, perfluoropolyether (PFPE), alkylated naphthalenes (AN), silicate esters, ionic fluids, multiply alkylated cyclopentanes (MAC), and combinations thereof.

Semi-solid lubricants include materials such as greases and can be formed by mixing oil such as mineral oil with thickeners and/or one or more solid lubricants.

Solid lubricants include non-liquid lubricants such as powders. Non-limiting examples of solid lubricant powders include dry graphite, PTFE, molybdenum disulphide, tungsten disulphide.

A lubricant to be coated onto fasteners includes at least one or more liquid lubricants. In some embodiments, a lubricant to be coated onto fasteners can include one or more semi-solid lubricants and/or one or more solid lubricants mixed with one or more liquid lubricants. In some embodiments, a lubricant to be coated onto fasteners includes at least 80% by weight of the one or more liquid lubricants, at least 90% by weight of the one or more liquid lubricants, or even at least 95% by weight of the one or more liquid lubricants. In some embodiments, a lubricant to be coated onto fasteners includes less than 10%, less than 5%, or even less than 3% by weight of non-liquid lubricants such as semi-solid lubricants and solid lubricants, and additives.

In some embodiments, a lubricant to be coated onto fasteners can include one or more additives. Additives can reduce friction and wear, adjust viscosity, increase resistance to corrosion, oxidation, aging, contamination, etc.

A lubricant coating can be applied in a manner that allows the lubricant to contact the entire exterior surface of the fasteners so that lubricant adheres to the fasteners in a manner that they satisfy the Brush Test, discussed below. For example, a plurality of fasteners can be dipped in a solvent-based solution of lubricant for a time period to sufficiently coat the fasteners. For example, a plurality of fasteners can be submerged in a bath of lubricant for a time period of greater than 5 minutes such as from 10 minutes to 24 hours, from 10 minutes to 5 hours, or even from 10 minutes to one hour. The fasteners can then be removed from the bath of lubricant so that excess lubricant can be separated, e.g., by “drip drying” and/or spinning the fasteners so that excess lubricant is separated due to centrifugal force.

After coating the fasteners with lubricant, the fasteners can be exposed to conditions to allow any solvent to be evaporated and allow the lubricant to cure. For example, the fasteners can be baked in an oven a temperature suitable to evaporate any solvent and cure the lubricant.

Optionally, prior to exposing fasteners to oxide growing conditions, the fasteners can be degreased and/or washed. Degreasing can be performed with a variety of degreasing compositions that include, e.g., naphtha, alkali ingredients, surfactants, and the like. After degreasing, the fasteners can be rinsed with water and oven dried.

FIG. 4 is a flow diagram of a non-limiting embodiment of a method oxidizing fasteners prior to lubricant coating according to the present disclosure, along with photographs of screw heads at the end of each indicated method step.

### Brush Test

Fasteners according to the present disclosure have been exposed to conditions to form enhanced metal oxide content (and enhanced surface-oxygen content) over the entire exterior surface of each fastener, the lubricant coating subsequently applied to each fastener has enhanced bonding to the fastener such that it satisfies the Brush Test.

A sample of fasteners made according to the present disclosure are tested in an automatic Screw Feeder according to the protocol below.

An automatic screw feeder is used such as the NSR-30 main component automatic screw feeder with SRR30SET swap rail set type commercially available from OHTAKE-ROOT KOGYO CO., LTD. No modifications were made to the automatic screw feeder.

Before adding the fasteners, the screw feeder is dip cleaned by wiping with 100% IPA.

To be representative of the various fasteners used in a hard disk drive, when evaluating fasteners made according to the present disclosure the Brush Test conducts two tests as outlined below for two types of fasteners (e.g., different sized fasteners).

One type of fasteners are loaded at a time to a screw feeder to the corner of the screw feeder up to about 50% of the screw feeder volume.

The screw feeder is then turned on in “running mode” so that it uninterruptedly brushes the fasteners for 3 hours. Then a visual mechanical inspection (VMI) is performed under a magnification of 10× on 50 fasteners for one or more “black stains.” If there is no “black stain”, then the 50 fasteners are returned to the screw feeder along with the remaining fasteners and then the screw feeder uninterruptedly brushes the fasteners for 1 additional hour (for a total of four hours). After the additional hour, 50 fasteners are randomly selected for visual mechanical inspection (VMI) under a magnification of 10× for one or more “black stains.”

### First and Second Test of Fasteners of a First Type

The above sequence is conducted as a “first test” for a first type of fastener. Then, the sequence is repeated for a “second test” for the first type of fastener.

### First and Second Test of Fasteners of a Second Type

The above sequence is separately conducted as a “first test” for a first a second type of fastener. Then, the sequence is repeated for a “second test” for the second type of fastener.

To pass or satisfy the “Brush Test” the combined results of the first and second tests for both types of fasteners must have a reject rate of 1% or less. As can be seen, a given Brush Test includes data from 200 total fastener data points (100 fastener data points from the first and second tests of the first type, and 100 fastener data points from the first and second tests of the first type). If only one fastener out of 200 had a black stain, then that would correspond to a reject rate of 0.5%, which would pass the Brush Test.

A “black stain” refers to visual black markings under 10× magnification due to particle generation caused by one or more of rubbing between multiple fasteners; rubbing between fasteners and the brushing mechanism in the screw feeder; and rubbing between fasteners.

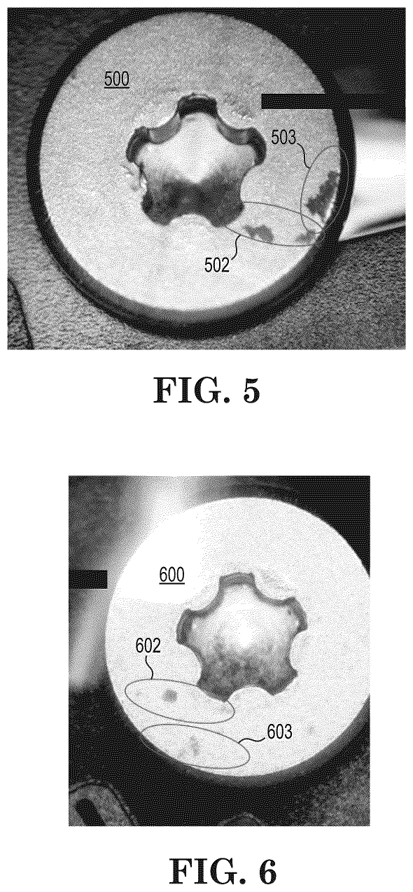

FIG. 5 is a photograph showing an example of a fastener 500 that includes black stains, indicated by circle 502 and circle 503, due to particles according to the Brush Test. FIG. 6 is another photograph showing an example of a fastener 600 that includes black stains, indicated by circle 602 and circle 603, due to particles according to the Brush Test.

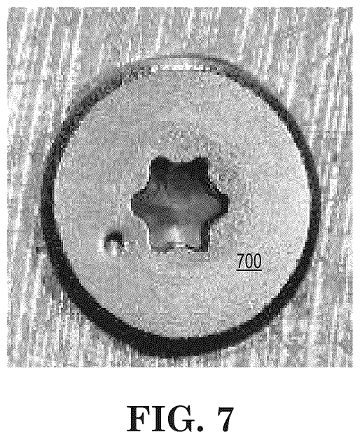

For comparison purposes, FIG. 7 is a photograph showing an example of a fastener 700 made according to the present disclosure that does not include any black stains.

### Example

Below is an example of how to conduct a Brush Test.

Two types of screws for use in a hard disk drive were used.

The first type of fastener used in Groups 1˜4 was a stainless-steel screw that is used to fasten a disk clamp within a hard disk drive.

The second type of fastener used in Groups 5-8 was a stainless-steel screw having a relatively larger head and that is used to fasten a voice coil motor assembly (VCMA) to the hard disk drive.

Each group of a given type of fastener had a different treatment with respect to growing an oxide layer prior to applying a lubricant. Also, as shown in the table below, each group had three trials (or three tests), which is not required for the Brush Test. As mentioned above, only two tests (or trials) are required for a given type of fastener.

TABLE 1

| | | | Brush | Brush | Brush | Brush | Brush | Brush | |
|---|---|---|---|---|---|---|---|---|---|
| | | | Testing | Testing | Testing | Testing | Testing | Testing | |
| | | | (3 hrs) | (3 hrs) | (3 hrs) | (4 hrs) | (4 hrs) | (4 hrs) | |
| Sample | PN | Pretreatment | 1st trial | 2nd trial | 3rd trial | 1st trial | 2nd trial | 3rd trial | Remarks |
| Group 1 | Clamp | None | Pass(0/50) | 10X(10/50) | | | | | Brush 3 hrs, 10X VMI |
| | Screw | | | | | | | | 50 pcs |
| Group 2 | | Pre-bake at | 1X(1/50) | 2X(2/50) | | | | | Brush 3 hrs, If no black |
| | | 300° C. for 2 | | | | | | | stain, brush one more |
| | | hours | | | | | | | hr, do VMI again |
| Group 3 | | Pre-bake at | Pass(0/50) | Pass(0/50) | Pass(0/50) | Pass(0/50) | Pass(0/50) | Pass(0/50) | Brush 3 hrs, If no black |
| | | 300° C. for 4 | | | | | | | stain, brush one more |
| | | hours | | | | | | | hr, do VMI again |
| Group 4 | | Soaking in | Pass(0/50) | Pass(0/50) | | Pass(0/50) | Pass(0/50) | | Brush 3 hrs, If no black |
| | | HNO₃ 45% at | | | | | | | stain, brush one more |
| | | 50° C. for 40 | | | | | | | hr, do VMI again |
| Group 5 | VCMA | None | Pass(0/50) | Pass(0/50) | | Pass(0/50) | Pass(0/50) | | Brush 3 hrs, 10X VMI |
| | Screw | | | | | | | | 50 pcs |
| Group 6 | | Pre-bake at | Pass(0/50) | 3X(3/50) | | Pass(0/50) | | | Brush 3 hrs, If no black |
| | | 300° C. for 2 | | | | | | | stain, brush one more |
| | | hours | | | | | | | hr, do VMI again |
| Group 7 | | Pre-bake at | Pass(0/50) | Pass(0/50) | Pass(0/50) | Pass(0/50) | Pass(0/50) | Pass(0/50) | Brush 3 hrs, If no black |
| | | 300° C. for 4 | | | | | | | stain, brash one more |
| | | hours | | | | | | | hr, do VMI again |
| Group 8 | | Soaking in | Pass(0/50) | 9X(9/50) | | Pass(0/50) | | | Brush 3 hrs, If no black |
| | | HNO₃ 45% at | | | | | | | stain, brush one more |
| | | 50° C. for 40 | | | | | | | hr, do VMI again |

TABLE 2

| | | 3 hr Screw Feeder | |
|---|---|---|---|
| | | Brushing-Individual | Total |
| | Pretreatment | Results for 2x Part | Reject Rate |
| Group | Description | Numbers (PN) | (%) |
| Group 1&5 | Control | 0/50, 10/50, 0/50, 0/50 | 10/200 = 5% |
| | (No Pretreatment) | | |
| Group 2&6 | 300 C. 2 hrs | 1/50, 2/50, 0/50, 3/50 | 6/200 = 3% |
| | Prebaking | | |
| Group 3&7 | 300 C. 4 hrs | 0/50, 0/50, 0/50, 0/50, | 0/300 = 0% |
| | Prebaking | 0/50, 0/50 | |
| Group 4&8 | 45% HNO3 50° C. | 0/50, 0/50, 0/50, 9/50 | 9/200 = 4.5% |
| | 40 min soaking | | |

As can be seen in Tables 1 and 2 above, the oxidation pretreatment of 4 hours at 300° C. in a convection oven prior to application of a lubricant (Groups 3 and 7) passed the Brush Test even if only the first two trials are considered. Groups 3 and 7 passed a third trial (or third test) as well.

Table 3 below shows surface-oxygen content by 2 kV EDX analysis of randomly picked 3 screws at 8 locations for control Group 1 three oxidation pretreatments (Groups 2-4). The surface oxygen levels of Group 4 (baked at 300 C for 4 hrs) are in the range of 13.07 wt % to 16.90 wt %, which is significantly higher than control Group 1 (without pre-baking) that has surface oxygen levels from 4.98 wt % to 7.78 wt %.

TABLE 3

| | | | Oxygen (% Weight) @ 2 kV | | | |
|---|---|---|---|---|---|---|
| | | | | Group 2 | | |
| | | | Group 1 | (HNO3 | Group 3 | Group 4 |
| | | | (without | 45 C. 50 C. | (Prebake | (Prebake |
| Sample | Location | Data | pretreatment) | 40 min) | 300 C. 2 hrs) | 300 C. 4 hr) |
| 1 | Screw | 1 | 6.21 | 4.60 | 15.40 | 14.99 |
| | thread | 2 | 6.11 | 4.29 | 15.02 | 14.34 |
| | Screw | 1 | 5.98 | 4.68 | 13.61 | 14.48 |
| | head- side | | | | | |
| 2 | Screw | 1 | 7.78 | 4.81 | 15.23 | 16.65 |
| | thread | 2 | 5.14 | 6.30 | 14.80 | 16.90 |
| | Screw | 1 | 6.49 | 4.55 | 13.11 | 13.07 |
| | head-side | | | | | |
| 3 | Screw | 1 | 4.98 | 4.07 | 12.42 | 13.79 |
| | head-side | 2 | 5.34 | 4.51 | 13.50 | 13.30 |
| | Average | | 6.00 | 4.73 | 14.14 | 14.69 |
| | Min | | 4.98 | 4.07 | 12.42 | 13.07 |
| | Max | | 7.78 | 6.30 | 15.40 | 16.90 |

What is claimed is:

1. A fastener comprising:
an elongated metal fastener body comprising:
a first end;
an opposed second end; and
a length extending between the first end and the second end;
a metal head at the first end of the elongated body, wherein the elongated metal fastener body and the metal head have an exterior surface comprising metal oxide; and
a lubricant coating over the entire exterior surface of the elongated metal fastener body and the metal head, wherein the lubricant coating includes one or more liquid lubricants, and wherein the fastener has a reject rate of 1% or less according to the Brush Test.

2. The fastener of claim 1, wherein the metal oxide is present over all of the exterior surface of the elongated metal fastener body and the metal head, and wherein all of the exterior surface of the elongated metal fastener body and the metal head has a surface-oxygen content of at least 8 percent by weight as measured by 2 kilovolts (kV) scanning electron microscopy (SEM) with 2 kilovolts (kV) energy-dispersive X-ray (EDX) spectroscopy.

3. The fastener of claim 1, wherein the elongated metal fastener body and the metal head include stainless steel.

4. The fastener of claim 3, wherein the stainless steel is chosen from austenitic stainless steel, martensitic stainless steel, and combinations thereof.

5. The fastener of claim 3, wherein the stainless steel is chosen from AISI type 410SS, AISI type 302, AISI type SS302HQ; UNS 24100 modified, and combinations thereof.

6. The fastener of claim 1, wherein the lubricant coating includes at least 80% by weight of the one or more liquid lubricants.

7. The fastener of claim 1, wherein the lubricant coating includes a mixture of the one or more liquid lubricants with one or more semi-solid lubricants, one or more solids lubricants, and combinations thereof.

8. The fastener of claim 1, wherein the one or more liquid lubricants are chosen from one or more mineral oils, one or more synthetic oils, and combinations thereof.

9. A data storage device comprising:
a housing having an interior gas space;
one or more electronic components disposed within the housing; and
at least one fastener of claim 1, wherein the at least one fastener is physically coupled to at least one component within the housing to secure the at least one component within the housing.

10. The data storage device of claim 9, wherein the data storage device is a hard disk drive, and wherein the one or more components are chosen from a disk clamp, one or more disk separator plates, a head stack bracket, a bottom voice coil magnetic assembly (VCMA), a top VCMA, a ramp structure, and combinations thereof.

11. A fastener comprising:
an elongated metal fastener body comprising:
a first end;
an opposed second end; and
a length extending between the first end and the second end;
a metal head at the first end of the elongated body, wherein the elongated metal fastener body and the metal head have an exterior surface comprising metal oxide; and
a lubricant coating over the entire exterior surface of the elongated metal fastener body and the metal head, wherein the metal oxide is present over all of the exterior surface of the elongated metal fastener body and the metal head, and wherein all of the exterior surface of the elongated metal fastener body and the metal head has a surface-oxygen content of at least 8 percent by weight as measured by 2 kilovolts (kV) scanning electron microscopy (SEM) with 2 kilovolts (kV) energy-dispersive X-ray (EDX) spectroscopy.

12. The fastener of claim 11, wherein the one or more liquid lubricants are chosen from one or more mineral oils, one or more synthetic oils, and combinations thereof.

13. A data storage device comprising:
a housing having an interior gas space;
one or more electronic components disposed within the housing; and
at least one fastener of claim 11, wherein the at least one fastener is physically coupled to at least one component within the housing to secure the at least one component within the housing.

14. The data storage device of claim 13, wherein the data storage device is a hard disk drive, and wherein the one or more components are chosen from a disk clamp, one or more disk separator plates, a head stack bracket, a bottom voice coil magnetic assembly (VCMA), a top VCMA, a ramp structure, and combinations thereof.

15. A method of forming a plurality of fasteners, wherein the method includes:
providing a plurality of metal fasteners exposed to ambient air, wherein each metal fastener has an exterior surface;
exposing the plurality of metal fasteners to non-ambient air conditions to form metal oxide on the exterior surface; and
coating a lubricant over the entire exterior surface, wherein the lubricant includes a liquid lubricant, and wherein the fastener has a reject rate of 0% according to the Brush Test.

16. The method of claim 15, wherein exposing the plurality of metal fasteners to non-ambient air conditions to form metal oxide on the exterior surface includes exposing the plurality of metal fasteners to a gas comprising oxygen for a time period of at least 30 minutes, wherein the temperature of the gas is at least 200° C.

17. The method of claim 16, wherein exposing the plurality of metal fasteners to a gas comprising oxygen includes exposing the plurality of fasteners to air in an oven for a time period of at least 3.5 hours, wherein the temperature of the air is from 250° C. to 700° C.

18. The method of claim 15, wherein exposing the plurality of metal fasteners to non-ambient air conditions to form metal oxide on the exterior surface includes contacting the plurality of metal fasteners with aqueous composition comprising one or more oxidizing agents for a time period of at least one hour, wherein the temperature of the aqueous composition is from 20° C. to 90° C.

19. The method of claim 15, wherein coating a lubricant over the entire exterior surface includes submerging the plurality of metal fasteners is a solution comprising the lubricant for a time period of at least 10 minutes.

20. The method of claim 15, further comprising cleaning the plurality of metal fasteners prior to exposing the plurality of metal fasteners to non-ambient air conditions to form metal oxide on the exterior surface.
